(19) United States
(12) Patent Application Publication
(10) Pub. No.: US 2011/0242021 A1
(43) Pub. Date: Oct. 6, 2011

(54) FLAT PANEL DISPLAY INTEGRATED TOUCH SCREEN PANEL AND FABRICATION METHOD THEREOF

(75) Inventors: Woo-Sik JUN, Yongin-city (KR); Jin-Woo PARK, Yongin-city (KR); Won-Kyu KWAK, Yongin-city (KR); Won-Woong JUNG, Yongin-city (KR); Dae-Hyun KIM, Yongin-city (KR); Tae-Hun KIM, Yongin-city (KR); Jae-Sun LEE, Yongin-city (KR); Ung-Soo LEE, Yongin-city (KR); Ryan CHOI, Yongin-city (KR); Kevin HEO, Yongin-city (KR)

(73) Assignee: SAMSUNG MOBILE DISPLAY CO., LTD., Yongin-City (KR)

(21) Appl. No.: 12/949,874

(22) Filed: Nov. 19, 2010

(30) Foreign Application Priority Data
Apr. 5, 2010 (KR) 10-2010-0030923

(51) Int. Cl. G06F 3/041; B05D 5/12

(52) U.S. Cl. 345/173; 427/58

(57) ABSTRACT

A structure for forming a touch screen panel directly on an upper substrate of a flat panel display device, and more particularly a touch screen panel integrated flat panel display device in which an insulating layer formed on the touch screen panel is implemented by a spin on glass (SOG layer having stable thermal property suitable for high temperature plastic process of a sealing material for encapsulating the upper substrate and a lower substrate of the flat panel display device, and a method of fabricating the same.

### CROSS-REFERENCE TO RELATED APPLICATION

This application claims priority to and the benefit of Korean Patent Application No. 10-2010-0030923, filed on Apr. 5, 2010, in the Korean Intellectual Property Office, the entire content of which is incorporated herein by reference.

### BACKGROUND

1. Field

The general inventive concept relates to a flat panel display device, and particularly to a touch screen panel integrated flat panel display device and a fabrication method thereof.

2. Description of the Related Art

A touch screen panel is an input device enabling a person to select an instruction displayed on a screen of an image display device with his/her finger or a tool and to input a user command.

To this end, the touch screen panel is provided in a front face of the image display device and converts a contact position on the screen with which a finger or a tool directly contacts into an electrical signal. By doing so, an instruction selected at the contact position is input as an input signal.

The touch screen panel shows a tendency to increase a range of applications because the touch screen panel can be a substitute of a separated input device such as a keyboard and a mouse that are coupled to an image display device.

The above information disclosed in this Related Art section is only for enhancement of understanding of the background of the invention and therefore it may contain information that does not form the prior art that is already known to a person of ordinary skill in the art.

### SUMMARY

Accordingly, aspects of the present invention have been made to provide a structure for forming a touch screen panel directly on an upper substrate of a flat panel display device, and more particularly a touch screen panel integrated flat panel display device in which an insulating layer formed on the touch screen panel may be implemented by a spin on glass (SOGO layer having stable thermal property suitable for high temperature plastic process of a sealing material for encapsulating the upper substrate and a lower substrate of the flat panel display device, and a method of fabricating the same.

In order to achieve the foregoing and/or other aspects of the present invention, according to an embodiment of the present invention, there is provided a touch screen panel integrated flat panel display device, including: an upper substrate and a lower substrate defined into a display region and a non-display region formed at outskirt of the display region; first and second sensing patterns formed on the display region of the upper substrate; connecting patterns for connecting the second sensing patterns to each other; a first insulating layer and a second insulating layer formed between the connecting patterns and the sensing patterns; and a sealing material formed between the non-display regions of the upper substrate and the lower substrate; wherein the first and second insulating layers are made of a spin on glass (SOG) material.

The SOG material may include at least one of siloxane compounds, silozene compounds, silicate compounds, and silsesquioxane compounds, and the first and second insulating layers have a thickness of 0.5 μm to 2 μm.

The first sensing patterns may include: first sensing cells arranged in one row whose X-coordinates are identical in a first direction; and first connecting lines for connecting the adjacent first sensing cells to each other, and the second sensing patterns include second sensing cells arranged in one column whose Y-coordinates are identical in a second direction.

The touch screen panel integrated flat panel display device further may include a plurality of metal patterns, arranged in an edge portion of a region where the first and second sensing patterns are formed, for electrically connecting one or a column of the sensing patterns to the sensing lines.

The plurality of connecting patterns and metal patterns may be formed on the same layer and may be made of a material having resistance lower than that of the first and second sensing patterns.

The lower substrate includes: a display region where a plurality of pixels including an organic light emitting devices having a plurality of first electrodes, an organic layer, and a plurality of second electrodes may be formed; and a non-display region including a driving circuit, positioned at outskirts of the display region, for driving the plurality of pixel.

In order to achieve the foregoing and/or other aspects of the present invention, according to another embodiment of the present invention, there is provided a method of fabricating a touch screen panel integrated flat panel display device, including: forming a touch screen panel including connecting patterns, a first insulating layer, first and second sensing patterns, and a second insulating layer on a display region of an upper substrate that is defined into the display region and a non-display region; performing a low temperature soft baking process to the first and second insulating layers; coating a sealing material between the upper substrate and a lower substrate that is positioned on the lower surface of the upper substrate; and performing a high temperature plasticizing process to the sealing material and a high temperature hardening process to the first and second insulating layers simultaneously; wherein the first and second insulating layers are made of a spin on glass (SOG) material.

The SOG material may be coated in a solution state in which a solid including at least one of siloxane compounds, silozene compounds, silicate compounds, and silsesquioxane compounds and a solvent for melting the solid may be mixed.

The soft baking process may be performed at temperature of 150° C. to 250° C. and the high temperature plasticizing process and the high temperature hardening process may be performed at temperature of 400° C. to 500° C.

The sealing material may be made into a gel state paste by adding an organic material to the frit including oxide powder and may be coated on the non-display region.

According to aspects of the present invention, the touch screen panel may be formed directly on the upper substrate of the flat panel display device such that the insulating layer formed on the touch screen panel may be implemented by the spin on glass (SOG) layer having stable thermal property suitable for the high temperature plastic process of a sealing material for encapsulating the upper substrate and the lower substrate of the flat panel display device, so that the thickness of the insulating layer is adjusted to improve the ESD characteristics and hardness characteristics are improved to overcome scratch inferior even when the protecting film is removed.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a plan view illustrating an upper substrate of a flat panel display device according to an embodiment of the present invention;

FIG. 2 is a sectional view of a specific portion (I-I′) of FIG. 1;

FIG. 3 is a plan view of a lower substrate of the flat panel display device corresponding to FIG. 1;

FIG. 4 is a graph illustrating light transmission of materials (silicon oxide, photo acryl, and SOG) used as an insulating layer; and

FIGS. 5A to 5C are sectional views illustrating a fabrication method of a touch screen panel integrated flat panel display device according to an embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to another element or be indirectly connected to the another element with one or more intervening elements interposed therebetween. Hereinafter, like reference numerals refer to like elements.

Recognizing that sizes and thicknesses of constituent members shown in the accompanying drawings are arbitrarily given for better understanding and ease of description, the present invention is not limited to the illustrated sizes and thicknesses.

In order to clarify the present invention, elements extrinsic to the description are omitted from the details of this description, and like reference numerals refer to like elements throughout the specification.

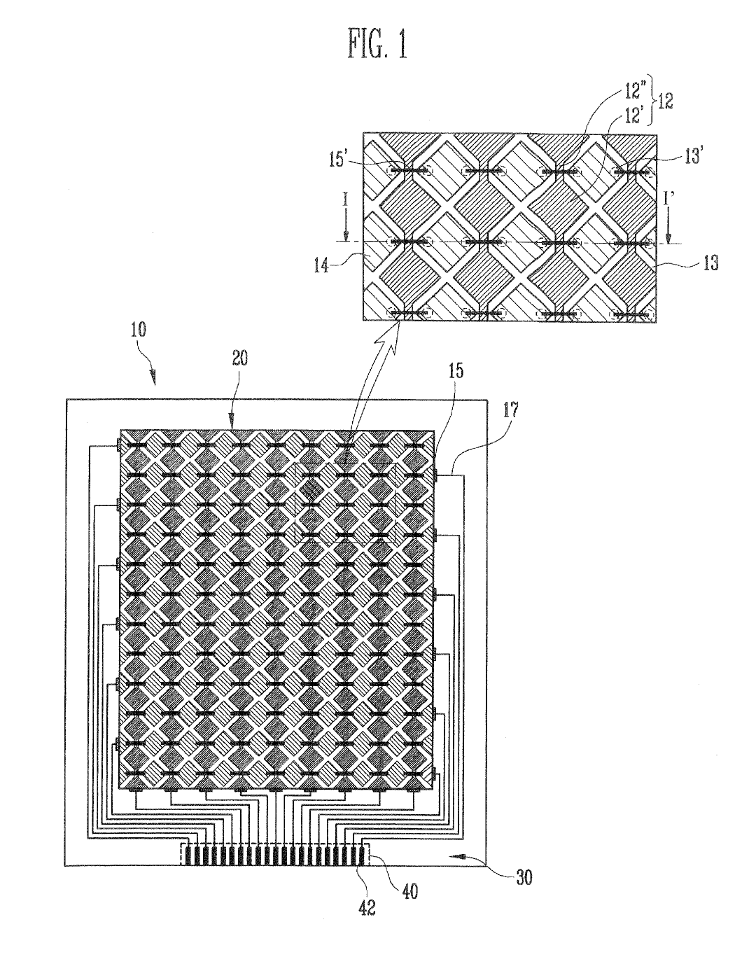

Hereinafter, the embodiments by which those skilled in the art may easily perform the present invention will be described in detail with reference to FIGS. 1 to 5.

Conventional touch screen panels include a resistive touch screen panel and a capacitive touch screen panel. The capacitive touch screen panel converts a contact position into an electric signal by sensing change of electrostatic capacity generated by a conductive sensing pattern in association with other sensing pattern or a ground electrode when a finger or an object contacts the touch screen.

The touch screen panel is attached to an outer surface of a flat panel display device such as a liquid crystal display (LCD) and an organic light emitting display (OLED) device. When the touch screen panel and the flat panel display device that are separately fabricated are attached to each other to use, the overall thickness of the product is increased and manufacturing costs are also increased.

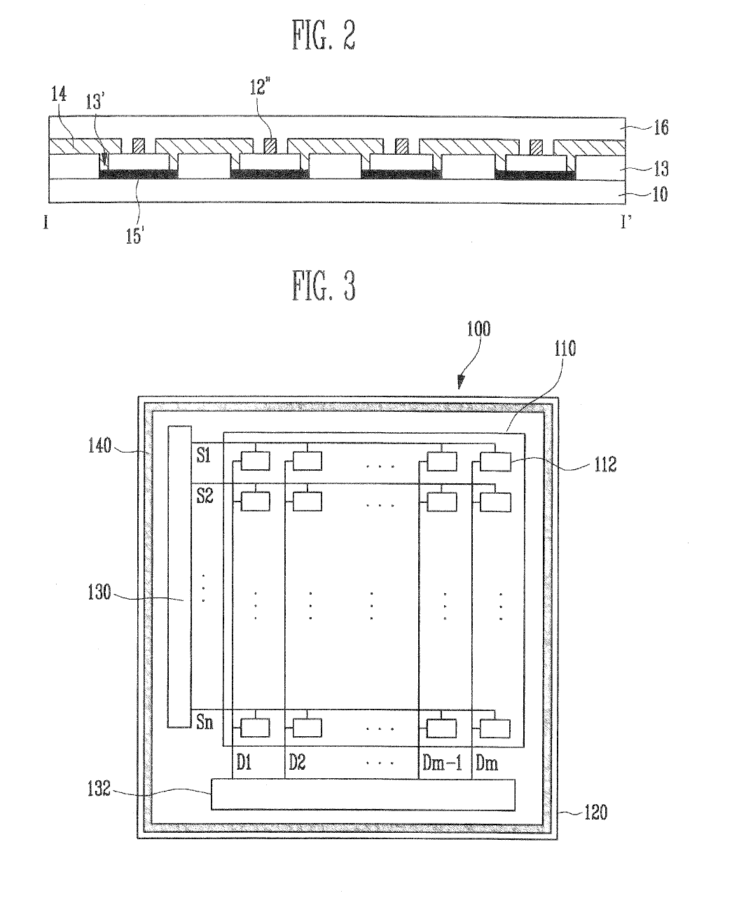

FIG. 1 is a plan view illustrating an upper substrate of a flat panel display device according to an embodiment of the present invention. FIG. 2 is a sectional view of a specific portion (I-I′) of FIG. 1.

FIG. 3 is a plan view of a lower substrate of the flat panel display device corresponding to FIG. 1.

Referring to FIGS. 1 and 2, the touch screen panel according to the embodiment of the present invention may be formed directly on an upper substrate 10 of the flat panel display device.

Here, the flat panel display device may be an organic light emitting display device or a liquid crystal device. In this embodiment of the present invention, the flat panel display device may be an organic light emitting display device. Therefore, the upper substrate 10 may be an encapsulating substrate of the organic light emitting display device, which may be made of a transparent material.

The touch screen panel according to the embodiment of the present invention includes a plurality of sensing patterns 12 and 14 formed on the upper substrate, that is, a first surface of the encapsulating substrate, and metal pads 15 and sensing lines 17 that may be electrically connected to the sensing patterns.

In this case, a region on which the plurality of sensing patterns 12 and 14 may be formed is a display region 20 where an image is displayed to detect a touch position. A region on which an FPC bonding pad unit 40 including the metal pads 15 and the sensing lines 17 electrically connected to the sensing patterns and a plurality of bonding pads 42 connected to the respective sensing lines 17 may be formed in a non-display region 30 provided at outskirts of the display region 20.

A sealing material 140 (See FIG. 3) for bonding the upper substrate and the lower substrate of the organic light emitting display device may be coated on a second surface of the upper substrate corresponding to the non-display region 30. That is, the sealing material 140 may be formed between the upper substrate 10 and the lower substrate 100 to seal the display regions 20 and 110 so as to prevent outer air from entering.

In this case, the lower substrate, as illustrated in FIG. 3, includes a display region 110 on which a plurality of pixels 112 including organic light emitting diodes (OLED) having a plurality of first electrode, organic layers, and second electrodes are formed and a non-display region 120 formed at outskirts of the display region 110.

The display region 110 may be a region where a predetermined image may be displayed by light emitted from the OLEDs, and includes a plurality of scan lines S1 to Sn arranged in a column direction, a plurality of data lines D1 to Dm arranged in a row direction, and a plurality of pixels 112, for receiving signals from driving circuits 130 and 132 for driving the OLEDs, formed on the scan lines S1 to Sn and the data lines D1 to Dm.

The non-display region 120 may be provided at the outskirts of the display region 110, and includes a driving circuit for driving the plurality of pixels 112 formed on the display region 110, that may be a data driving circuit 132 and a scan driving circuit 130, and the sealing material 140 for bonding the lower substrate 100 to the upper substrate 10.

That is, the display region 110 and the non-display region 120 of the lower substrate 100 are overlapped with the display region 20 and the non-display region 30 of the upper substrate 10 as shown in FIG. 1, respectively.

The sensing patterns formed on the display region 20 of the upper substrate 10 are alternately arranged and include the first and second sensing patterns 12 and 14 in which X-coordinates are connected to each other every same one row unit or Y-coordinates are connected to each other every same one column unit.

That is, the first sensing patterns 12 include first sensing cells 12′ whose X-coordinates are arranged in a same row in the first direction (row direction) and first connecting lines 12″ for connecting adjacent first sensing cells 12′ to each other. The second sensing patterns 14 include second sensing cells 14 whose Y-coordinates are arranged in a same column in the second direction (column direction).

In this embodiment of the present invention, the first sensing patterns 12 and the second sensing patterns 14 are formed on the same layer, and must be made of a transparent material for implementing operation of the touch screen panel. Therefore, the first and second sensing patterns 12 and 14 may be made of a transparent conductive material, for example, indium-tin oxide (hereinafter, referred to ITO).

In order for the first sensing patterns 12 and the second sensing patterns 14 to serve as sensing electrodes, the respective sensing cells arranged in the first direction and in the second direction must be electrically connected to each other.

Then, the first sensing cells 12′ are electrically connected to each other by means of the first connecting lines 12″. However, since the second sensing cells 14 for forming the second sensing patterns are formed on the same layer of the first sensing cells 12′, connecting lines intersecting with the first connecting lines cannot be formed on the same layer in order to avoid short with the first connecting lines 12′.

Thus, in this embodiment of the present invention, respective connecting patterns 15′ for electrically connecting the second sensing cells 14 to each other are formed on a layer different from the layer on which the first sensing patterns 12 are formed, that is, on the lower layer of the first and second sensing patterns 12 and 14.

That is, in the touch screen panel according to the embodiment of the present invention, the connecting patterns 15′ are formed on a transparent substrate as the upper substrate 10 and the first insulating layer 13 may be formed on the transparent substrate 11 including the connecting patterns 15′.

In this case, the connecting patterns 15′ may be made of ITO like the first and second sensing patterns 12 and 14 or a metal having lower resistance than that of ITO.

Moreover, the connecting patterns 15′, as illustrated in the drawings, may have a rectangular bar shape, but the present invention is not limited to the shape. That is, the connecting patterns 15′ may have a shape in which a width of ends of the connecting patterns 15′ that are exposed by contact holes 13′ of the insulating layer 13 may be wider than widths of other portions of the connecting patterns 15′.

The connecting patterns 15′ intersect first connecting lines 12″ of the first sensing patterns 12 and the width of the connecting patterns 15′ may be minimized to reduce influence from parasitic capacitance that is generated by the intersection.

However, when the width of the connecting patterns 15′ may be minimized as described above, line resistance of the respective second sensing patterns 14 may be increased so that sensitivity for implementing the function of the touch screen panel may be inferior.

Therefore, the connecting patterns 15′ may be made of a conductive material having low resistance.

In this case, the connecting patterns 15′ are formed in an edge region of the region where the first sensing patterns 12 and the second sensing patterns 14 are formed and are made of the same material as that of the metal pad 15 for supplying a detected signal to a driving circuit (not shown). Since the connecting patterns 15′ are formed on the same layer and by the same process as the metal pad, an additional mask process for forming the connecting patterns 15′ does not need.

Therefore, the line resistance may be prevented from increasing because the connecting patterns 15′ are not made of the transparent conductive material such as the first and second sensing patterns 12 and 14 and disadvantage of adding the mask process of forming the connecting patterns 15′ may be overcome. In addition, a second insulating layer 16 may be formed on the first and second sensing patterns 12 and 14.

As described above, the touch screen panel according to the embodiment of the present invention may be formed on the first surface of the upper substrate 10 and a sealing material for bonding the upper substrate to the lower substrate of the flat panel display device may be coated on the second surface corresponding to the non-display region of the upper substrate.

At this time, the sealing material 140 may be a solid state frit, wherein the fit generally includes oxide powder mixed with glass powder.

Organic material may be added to the frit including the oxide powder to form gel state paste and the gel state paste may be plasticized at high temperature 400° C. to 500° C.

When the frit is plasticized as described above, the organic material may be dissipated into air and the gel state paste may be hardened to be a solid state frit so that the upper substrate and the lower substrate are bonded.

At this time, a process of projecting laser onto the hardened fit to be melted and hardened repeatedly may be added so that the bonding between the upper and lower substrates can be secured.

That is, in order to implement the touch screen panel integrated flat panel display device according to the embodiment of the present invention, the sealing material 140 for sealing the upper and lower substrate must be coated and the high temperature plastic process thereof must be performed.

However, prior to performance of the sealing between the upper substrate and the lower substrate, the touch screen panel is already formed on the first surface of the upper substrate. In this case, the high temperature plastic process performed to the sealing material (frit) has influence to respective layers for forming the touch screen panel formed on the first surface of the upper substrate 10.

Therefore, the first and second insulating layers 13 and 16 for forming the touch screen panel must be made of material capable of maintaining insulation property even during the high temperature plastic process, and therefore organic material other than inorganic material such as silicon oxide (SiO₂) cannot be used.

In addition, when the silicon oxide is used as an insulating layer, the insulating layer has a thickness of 2000 to 4000 Å but this thickness may be two thin to prevent inferiority due to ESD entering from the outside. In order to increase the thickness of the silicon oxide layer, film forming time and dry etching time are considerably increased.

In the embodiment of the present invention, in order to overcome the above-mentioned drawbacks, the first and second insulating layers 13 and 16 formed on the touch screen panel are made of spin on glass (SOG) having stable thermal property suitable for the high temperature plastic process performed to the sealing material.

The SOG layer may be coated by a spin coating method, and includes at least one of siloxane compounds (for example, (oligo) siloxane [general name of compounds consisting of siloxane bond Si—O, molecular formula: (H₃Si)₍ₙ₊₁₎Oₙ], organo-siloxane [general name of compounds including siloxane bonding having carbon, molecular formula: (CH₃)(H₂Si)₍ₙ₊₁₎Oₙ], organo-alkoxysiloxan [general name of compounds including siloxane bonding having hydrocarbon, molecular formula: (CₘH₂ₘ₋₁)(H₂Si)₍ₙ₊₁₎Oₙ], perfluoro-allkoxysiloxan [general name of compounds including siloxane bonding having perfluorochain, molecular formula: (CF₃)ₙ(CₘH₂ₘ₋₁)(H₂Si)₍ₙ₊₁₎Oₙ], methacrylate and epoxy groups as functional groups included in soloxane compound so as to enable UV or thermosetting), silozne compounds, silicate compounds, silsesquioxane compounds (including silsesquioxane (HSQ)).

In addition, such compounds are mixed into an ether solvent such as propylene glycol monomethyl ether acetate (PGMEA), polypropylene glycol methyl ether (PGME), Methyl isobutyl ketone (MIBK), N-Methyl-2-pyrrolidinone (NMP), Normal butyl acetate (NBA), and Ethyl lactate (EL), an acetate solvent, and a ketone solvent.

Since such SOG layer implements a flat insulating layer by a simple coating method as well as maintains insulation property even during the high temperature process as described above, the SOG layer can be used as the first and second insulating layers 13 and 16 of the touch screen panel with respect to the flat panel display device in which the touch screen panel may be integrated on the upper substrate.

Particularly, since the SOG layer may be formed by a simple coating method such as spin coating, the thickness thereof can be easily controlled, so that it is advantageous in view of ESD protection against static electricity applied from the outside of the touch screen panel.

The existing silicon oxide layer (SiO2) has a break voltage indicating insulation property of the insulating layer of about −7.34 MV/cm and the SOG layer has a BV of about −7.56 MV/cm similar thereto. However, as listed in Table 1, in the results of ESD inferiority test, the ESD inferiority may be generated from a thin silicon oxide layer.

TABLE 1

| Applied voltage (kV) | SiO2 3000 Å | SOG 1 μm |
|---|---|---|
| 1 | 0 | 0 |
| 1.5 | 2 | 0 |
| 2 | 10 | 0 |
| 2.5 | 10 | 0 |
| 3.0 | 10 | 0 |
| 3.5 | 10 | 0 |
| 4 | 10 | 10 |

Table 1 lists experimental data indicating the ESD estimation results of a case when the silicon oxide layer with 3000 Å may be used as an insulating layer in the touch screen panel and a case when the SOG layer with 1 μm may be used. The data are obtained by estimating 10 touch screen panels and by applying voltages of ±1 kV, ±1.5 kV, ±2 kV, ±2.5 kV, ±3.0 kV, ±3.5 kV, and ±4.0 kV to the display region of the edge portion of the upper top end of the touch screen panel every five times (estimation standard: human body model (HBM) R−1.5 kΩ, C=100 pF).

According to Table 1, in a case where a silicon oxide layer of 3000 Å may be used, the inferiority is found in all panels (10 panels) when static electricity higher than 2 kV is applied. However, in a case where the SOG layer of 1 μm on is used, the ESD inferiority can be overcome until static electricity of 3 kV is applied.

That is, although BV property may be similar, the ESD inferiority can be overcome when the thickness of the insulating layer may be increased. As described above, the existing silicon oxide layer has a thickness of about 2000 to 4000 Å. Since it takes a considerable long time for forming a layer and dry etching when the silicon oxide layer has a thickness thicker than 4000 Å, the thickness may be actually about 3000 Å.

However, although it may be difficult for the thickness to overcome the ESD inferiority caused by the static electricity applied from the outside, the thickness may be easily controlled by the spin coating method when the insulating layer is implemented by the SOG layer like the present invention so that the SOG insulating layer can be sufficiently formed to have a thickness of about 0.5 μm to 2 μm in mass production.

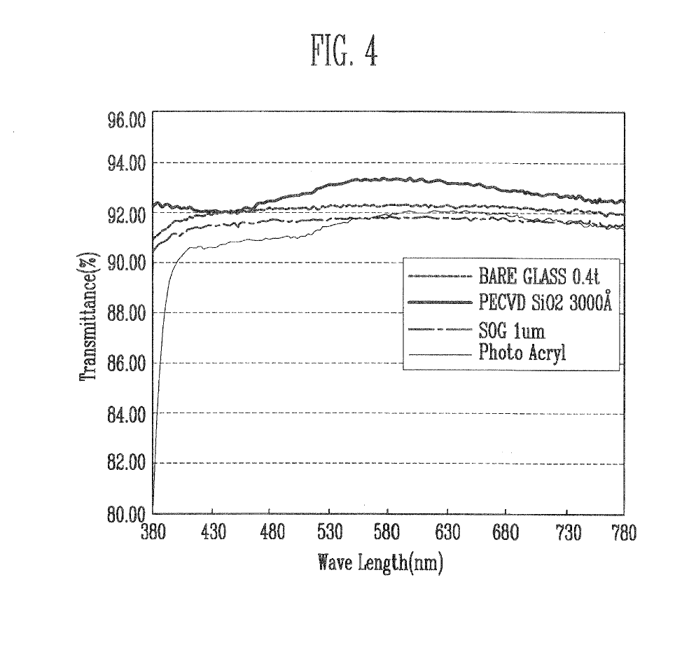

Decrease of light transmission that may occur when the SOG layer is formed thick is not a problem as illustrated in the graph of FIG. 4 and the results listed in Table 2.

FIG. 4 is a graph illustrating light transmission of materials (silicon oxide, photo acryl, and SOG) used as an insulating layer, and Table 2 lists experimental data indicating transmission by wavelength.

TABLE 2
Measuring instrument: Perkin Elmer Lamda 950

| Wavelength | Silicon oxide | | Organic insulating layer |
|---|---|---|---|
| (nm) | (SiO2) 1000 Å | SOG 1 μm | (Photo Acryl) |
| 380 | 92.21 | 90.44 | 78.14 |
| 550 | 93.28 | 91.78 | 91.70 |
| 780 | 92.33 | 91.50 | 91.24 |

Referring to FIG. 4 and Table 2, since the SOG layer having a thickness of 1 μm has transmission higher than about 90%, when the first and second insulating layers 13 and 16 of the touch screen panel are made of the SOG layer like the embodiment of the present invention, the ESD inferiority can be improved without inferior transmission.

In addition, since hardness of a pencil may be higher than about 4 H, the SOG layer is advantageous in scratch inferiority.

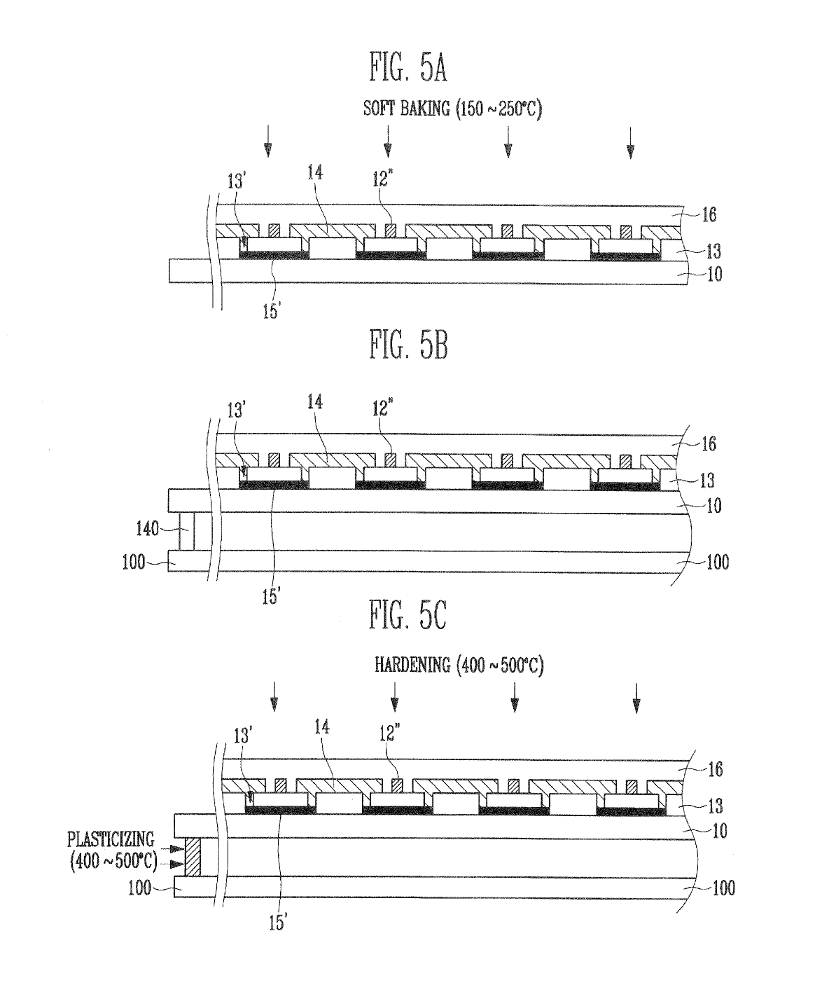

FIGS. 5A to 5C are sectional views illustrating a fabrication method of a touch screen panel integrated flat panel display device according to an embodiment of the present invention.

This will be described by focusing sections of one region of the display region and one region of the non-display region.

First, referring to FIG. 5A, the touch screen panel may be formed on the upper substrate 10 of the flat panel display device.

In this case, since the sectional structure of the touch screen panel may be identical to the section as illustrated in FIG. 2, its detailed description will be omitted and same reference numeral are used.

In the embodiment of the present invention, the first and second insulating layers 13 and 16 formed on the touch screen panel are made of the SOG layer.

Particularly, in the step as illustrated in FIG. 5A, that is, in the step of forming the touch screen panel on the upper substrate, the SOG layers as the first and second insulating layers 13 and 16 are implemented by heating at low temperature of about 150° C. to 250° C. to remove solvent component by a soft baking process.

More specifically, the SOG layer may be coated on the first surface of the upper substrate in the solution in which solid including at least one of siloxane compounds, silozene compounds, silicate compounds, and silsesquioxane compounds and a solvent for melting the solid are mixed.

After that, the solution becomes a final SOG layer through the low temperature baking and the high temperature hardness process. In the step as illustrated in FIG. 5A, only the low temperature soft baking process may be performed to the SOG solution so that the SOG layer may be formed.

The soft baking process may be performed at low temperature of about 150 to 250° C. Due to this process, a provisional SOG layer in which solvent of the SOG solution re removed may be formed and maintains basic property of an insulating layer.

As illustrated in FIG. 5B, the sealing material may be coated on the second surface corresponding to the non-display region of the upper substrate and the non-display region of the lower substrate.

Since the structure of the lower substrate has been described with reference to FIG. 3, its detailed description will be omitted.

The sealing material may be formed between the upper substrate 10 and the lower substrate 100 to seal the display region 20 such that outer air cannot enter therebetween. In the embodiment of the present invention, a solid frit may be used as the sealing material 140.

In this case, the fit may be made of oxide powder included in glass powder. Organic material may be added to the fit including the oxide powder to form a gel state paste to be coated on the non-display region.

Referring to FIG. 5C, a process of plasticizing the sealing material at high temperature of about 400° C. to 500° C. may be performed. When the frit is plasticized, the organic material may be dissipated into air and the gel state paste may be hardened and becomes the solid frit so that the upper substrate and the lower substrate are bonded to each other.

In addition, as described above, the SOG layer may be formed into a final SOG layer by the soft baking process and the high temperature hardening process. In the embodiment of the present invention, the hardening process of the SOG layer may be performed while the high temperature plasticizing process may be performed to the sealing material.

That is, the SOG layers as the first and second insulating layers 13 and 16 that are formed on the first surface of the upper substrate are finally and completely hardened to exhibit property of the SOG layer as described above with reference to Table 1 and Table 2.

In other words, according to the embodiment of the present invention, the high temperature hardening process of the SOG layer formed on the touch screen panel may be performed with the sealing process of the upper and lower substrates so that the processing time can be reduced and fabrication costs can be reduced.

The present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A touch screen panel integrated flat panel display device, comprising:
an upper substrate and a lower substrate defined into a display region and a non-display region formed at outskirt of the display region;
first and second sensing patterns formed on the display region of the upper substrate;
connecting patterns for connecting the second sensing patterns to each other;
a first insulating layer and a second insulating layer formed between the connecting patterns and the sensing patterns; and
a sealing material formed between the non-display regions of the upper substrate and the lower substrate;
wherein the first and second insulating layers are made of a spin on glass (SOG) material.

2. The touch screen panel integrated flat panel display device as claimed in claim 1, wherein the SOG material includes at least one of siloxane compounds, silozene compounds, silicate compounds, and silsesquioxane compounds.

3. The touch screen panel integrated flat panel display device as claimed in claim 1, wherein the first and second insulating layers have a thickness of 0.5 μm to 2 μm.

4. The touch screen panel integrated flat panel display device as claimed in claim 1, wherein the first sensing patterns include:
first sensing cells arranged in one row whose X-coordinates are identical in a first direction; and
first connecting lines for connecting the adjacent first sensing cells to each other.

5. The touch screen panel integrated flat panel display device as claimed in claim 1, wherein the second sensing patterns include second sensing cells arranged in one column whose Y-coordinates are identical in a second direction.

6. The touch screen panel integrated flat panel display device as claimed in claim 1, further comprising a plurality of metal patterns, arranged in an edge portion of a region where the first and second sensing patterns are formed, for electrically connecting one or a column of the sensing patterns to the sensing lines.

7. The touch screen panel integrated flat panel display device as claimed in claim 6, wherein the plurality of connecting patterns and metal patterns are formed on the same layer and are made of a material having resistance lower than that of the first and second sensing patterns.

8. The touch screen panel integrated flat panel display device as claimed in claim 1, wherein the lower substrate comprises:
a display region where a plurality of pixels including an organic light emitting devices having a plurality of first electrodes, an organic layer, and a plurality of second electrodes are formed; and
a non-display region including a driving circuit, positioned at outskirts of the display region, for driving the plurality of pixel.

9. A method of fabricating a touch screen panel integrated flat panel display device, the method comprising:
forming a touch screen panel including connecting patterns, a first insulating layer, first and second sensing patterns, and a second insulating layer on a display region of an upper substrate that is defined into the display region and a non-display region;
performing a low temperature soft baking process to the first and second insulating layers;
coating a sealing material between the upper substrate and a lower substrate that is positioned on the lower surface of the upper substrate; and
performing a high temperature plasticizing process to the sealing material and a high temperature hardening process to the first and second insulating layers simultaneously;
wherein the first and second insulating layers are made of a spin on glass (SOG) material.

10. The method as claimed in claim 9, wherein the SOG material is coated in a solution state in which a solid including at least one of siloxane compounds, silozene compounds, silicate compounds, and silsesquioxane compounds and a solvent for melting the solid are mixed.

11. The method as claimed in claim 9, wherein the soft baking process is performed at temperature of 150° C. to 250° C.

12. The method as claimed in claim 9, wherein the high temperature plasticizing process and the high temperature hardening process are performed at temperature of 400° C. to 500° C.

13. The method as claimed in claim 9, wherein the sealing material is made into a gel state paste by adding an organic material to the fit including oxide powder and is coated on the non-display region.

14. A method of fabricating a touch screen panel integrated flat panel display device, said touch screen panel having an upper and lower substrate having display and non-display regions, first sensing patterns and second sensing patterns on the display region of the upper substrate connecting patterns connecting the second sensing patterns, a first insulating layer disposed between the connecting patterns and the first and second sensing patterns, the first and second sensing patterns disposed between the connecting patterns and the first and second sensing patterns, and a second insulating layer on the display region of an upper substrate that is disposed on the display region and a non-display region, comprising:
forming the touch screen panel;
performing a low temperature soft baking process to the first and second insulating layers;
coating a sealing material between the upper substrate and the lower substrate that is positioned on the lower surface of the upper substrate; and
performing a high temperature plasticizing process to the sealing material and a high temperature hardening process to the first and second insulating layers simultaneously;
wherein the first and second insulating layers are made of a spin on glass (SOG) material.

15. The method as claimed in claim 14, wherein the SOG material is coated in a solution state in which a solid including at least one of siloxane compounds, silozene compounds, silicate compounds, and silsesquioxane compounds and a solvent for melting the solid are mixed.

16. The method as claimed in claim 14, wherein the soft baking process is performed at temperature of 150° C. to 250° C.

17. The method as claimed in claim 14, wherein the high temperature plasticizing process and the high temperature hardening process are performed at temperature of 400° C. to 500° C.

18. The method as claimed in claim 14, wherein the sealing material is made into a gel state paste by adding an organic material to the frit including oxide powder and is coated on the non-display region.

19. The method as claimed in claim 14, further comprising
forming a plurality of metal patterns, arranged in an edge portion of a region where the first and second sensing patterns are formed, for electrically connecting one or a column of the sensing patterns to sensing lines.

20. The touch screen panel integrated flat panel display device as claimed in claim 19, wherein the plurality of metal patterns and connecting patterns are formed on the same layer and are made of a material having a resistance lower than that of the first and second sensing patterns.
